(19) United States
(12) Patent Application Publication
(10) Pub. No.: US 2013/0014262 A1
(43) Pub. Date: Jan. 10, 2013

(54) MOBILE COMMUNICATION TERMINAL HAVING A BEHAVIOR-BASED MALICIOUS CODE DETECTION FUNCTION AND DETECTION METHOD THEREOF

(75) Inventors: Jae Hun Lee, Daejeon (KR); Jin Ha Nam, Gyeonggi-do (KR); Sung Keun Lee, Gyeonggi-do (KR)

(73) Assignee: AHNLAB, INC., Gyeonggi-do (KR)

(21) Appl. No.: 13/638,103

(22) PCT Filed: Mar. 30, 2011
(86) PCT No.: PCT/KR11/02176

§ 371 Date: Sep. 28, 2012

(30) Foreign Application Priority Data
Mar. 30, 2010 (KR) 1020100028297

(51) Int. Cl. G06F 21/00

(52) U.S. Cl. 726/24

(57) ABSTRACT

A mobile communication terminal comprises: a system unit which performs application installation and removal, outputs an installation completion message upon completion of the application installation, and provides, upon receipt of request for authority information on the application, the requested authority information; a behavior information database in which behavior information data is stored; and an inspection unit which makes a request for the authority information to the system unit and receives the authority information, upon receipt of the installation completion message from the system unit, and which compares the authority information and the behavior information data stored in the behavior information database to examine whether the application is a malicious code or not.

### FIELD OF THE INVENTION

The present invention relates to a technique for diagnosing a malicious behavior by a malicious code in a mobile communication terminal, and more particularly, to a mobile communication terminal such as a smart terminal having a malicious code diagnosing function based on a behavior, which are suitable for detecting a malicious code distributed to and executed in the mobile communication terminal, and method for diagnosing a malicious code.

### BACKGROUND

These days, mobile communication terminals become necessities of modern people, allowing users to make a call, send a message, or access the wireless Internet, thus implementing various ubiquitous environments. In addition, the popularity of smart terminals having a combined advantage of portable phones and personal digital assistants (PDAs) is rapidly on the rise domestically as well as overseas.

However, as the use of smart terminals is increasing, methods for attacking mobile malicious codes have been more diversified. For example, numerous malicious codes such as mobile virus, mobile warm, mobile Trojan horse, mobile spyware or the like have been produced and distributed, which may potentially lead to a leakage of personal information included in smart terminals and damage to financial transactions.

As a countermeasure, in order to detect malicious codes that may be used in mobile communication terminals including smart terminals, various virus diagnosis businesses and security research institutes and the like use a method of diagnosing malicious codes by using a digital signature or a method of diagnosing malicious codes by checking whether or not an application programming interface (API) has been used in a target file of a mobile communication terminal for inspection. A relevant prior art is disclosed in Korean Patent Laid-Open Publication No. 2009-0130990 (Laid-Open Publication date: Dec. 28, 2009).

However, in the methods of the above-mentioned related arts for diagnosing a malicious code in a mobile communication terminal, information such as a file system, a process, a registry and the like is collected or capability of an application is monitored in order to detect information on every behavior, so considerable system resource is wasted. Thus, efficiency of the mobile communication terminals and utilization of resource are degraded.

### SUMMARY

In view of the above, therefore, the present invention provides a mobile communication terminal and a method for diagnosing a malicious code in the mobile communication terminal based on behavior-based information.

In accordance with a first aspect of the present invention, there is provided a mobile communication terminal having a behavior-based malicious code diagnosing capability, the mobile communication terminal including: a system unit configured to perform installation and deletion of an application, output an installation complete message when the installation of the application is completed, and provide authority information regarding the application when the authority information regarding the application is requested; a behavior information database which stores behavior information data; and an inspection unit configured to request the authority information to receive it from the system unit when receiving the installation complete message from the system unit, and compare the authority information with the behavior information data stored in the behavior information DB to diagnose whether or not the application is a malicious code.

In accordance with a second aspect of the present invention, there is provided a method for diagnosing a malicious code on a behavior basis for use in a mobile communication terminal having a behavior information database that stores behavior information data, the method including: performing installation of an application at a system unit of the mobile communication terminal; transferring an installation complete message to an inspection unit when the installation of the application is completed; upon receipt of the installation complete message, requesting authority information to the system unit at the inspection unit; and comparing, at the inspection unit, the authority information received from the system unit with the behavior information data stored in the behavior information DB to diagnose whether or not the application is a malicious code.

In accordance with a third aspect of the present invention, there is provided a method for diagnosing a malicious code on a behavior basis in a mobile communication terminal having a behavior information database that stores behavior information data, the method including: receiving, at an inspection unit, an installation complete message from the system unit when an application is installed in a system unit of the mobile communication terminal; requesting, at the inspection unit, authority information to the system unit and receiving the authority information; comparing the authority information with the behavior information data stored in the behavior information DB; and measuring a score of each behavior included in the authority information on a basis of preset malicious code behavior reference information, and when the sum of the measured scores is higher than the reference score, diagnosing the application as a malicious code.

According to the mobile communication terminal and the method with the behavior-based malicious code diagnosing capability in accordance with embodiments of the present invention, malicious codes which are increased in geometrical progression can be quickly and effectively diagnosed, thus enhancing resource utilization of the mobile communication terminal.

Further, malicious codes, which are not diagnosed in a signature-based malicious code inspection, can be detected by using behavior-based information, thus enhancing stability of a mobile terminal.

### BRIEF DESCRIPTION OF THE DRAWINGS

The above and other objects and features of the present invention will become apparent from the following description of embodiments, given in conjunction with the accompanying drawings, in which:

FIG. 1 illustrates a block diagram of a mobile communication terminal in accordance with an embodiment of the present invention;

FIG. 2 is a flow chart illustrating a process of an operation of the mobile communication terminal in accordance with an embodiment of the present invention; and

FIG. 3 is a flow chart illustrating a process performed by an inspection unit in a controller of the mobile communication terminal in accordance with an embodiment of the present invention.

### DETAILED DESCRIPTION

The advantages and features of the present invention and methods of accomplishing these will become apparent from the following embodiments taken in conjunction with the accompanying drawings. In the following description of the embodiments of the present invention, well-known functions or constitutions will not be described in detail if they would obscure the invention in unnecessary detail. Further, the terminologies to be described below are defined in consideration of functions in the embodiments of the present invention and may vary depending on a user's or operator's intention, practice or the like. Therefore, the present invention will be defined based on the overall description of the present application.

Hereinafter, embodiments of the present invention will be described in detail with the accompanying drawings.

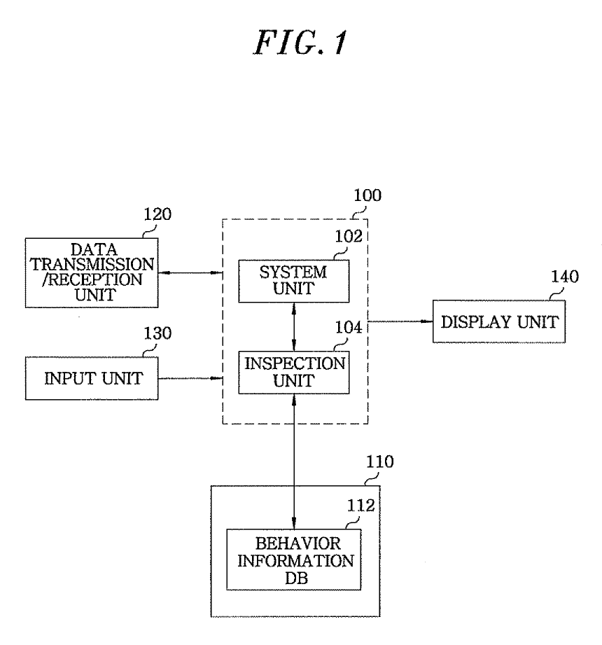

FIG. 1 illustrates a block diagram of a mobile communication terminal in accordance with an embodiment of the present invention.

In the embodiment, a mobile communication terminal may be a smart phone, a mobile phone, a personal digital assistant (PDA), a portable media player (PMP) or the like, which has communication capabilities.

As illustrated in FIG. 1, the mobile communication terminal includes a controller 100, a memory unit 110, a data transmission/reception unit 120, an input unit 130, and a display unit 140. The controller 100 includes a system unit 102 and an inspection unit 104.

The memory unit 110, which may include a hard disk, a read only memory (ROM), a random access memory (RAM) or the like, stores an operating program of the mobile communication terminal. The operating program may be generally designated software programmed to operate an internal applications and the like of the mobile communication terminal in advance when the mobile communication terminal is manufactured. Further, the memory unit 110 includes a behavior information database (DB) 112 which stores behavior information data of malicious codes as described below. In this embodiment, the behavior information data includes information regarding a behavior reference of malicious codes and a reference score as a reference used for determining a malicious code.

The controller 100 controls an overall operation of the mobile communication terminal based on the operating program stored in the memory unit 110, and is connected to the data transmission/reception unit 120, the input unit 130, and the display unit 140 to manage input/output of data thereto and therefrom.

The data transmission/reception unit 120 transfers voice and various multimedia data received from an external wireless communication network through an antenna (not shown) to the controller 100, and transmits various data provided from the controller 100 to the external wireless communication network. Further, the data transmission/reception unit 120 may have a short-range communication capability such as infrared communication, Bluetooth, and wireless network protocols (e.g., IEEE 802.11 series) and the like so that data transmission and reception can be performed with another mobile communication terminals or a computer.

The input unit 130 serves to receive a user command and transmit the received command signal to the controller 100. The input unit 130 may include a keypad and a data reception interface unit. In this case, the keypad includes multiple number keys, and when a user presses a certain key on the keypad, a corresponding key data signal is generated and provided to the controller 100. Keypads may be difference in character arrangements by manufacturers and countries, and some smart terminals may provide keypads displayed in a touch screen scheme on a display unit whenever necessary depending on software, rather than physical keypads.

In addition, the data reception interface unit may be, for example, a universal serial bus (USB) interface unit, and when it is interconnected with a computer by a user using a USB type fixed line cable, data may be received therethrough.

The display unit 140 displays various types of information generated in the mobile communication terminal under the control of the controller 100. For example, the display unit 140 may display data input through the input unit 130 and various pieces of information provided from the controller 100 upon receiving the same.

Meanwhile, the system unit 102 of the controller 100 in the mobile communication terminal installs an application received from the data transmission/reception unit 120 and the input unit 130 in the memory unit 110 such that the application can be driven within the mobile communication terminal. In this case, before the application is installed, the system unit 102 recognizes information regarding authority of the application based on a preset process and presents the recognized authority to the user. The system unit 102 then installs the application before the user agrees it (that is, when the user agrees that the authority of the application is permitted). That is, the system unit 102 may limit a behavior of the corresponding application depending on whether or not the user agrees it.

In general, as in the existing computer, a user agrees with the permission of the authority without paying any particular attention thereto to install an application. That is, the user does not check whether or not an application to be installed is a malicious program. According to the embodiment, the inspection unit 104 inspects authority information of an application to determine whether or not the corresponding application is malicious.

In the embodiment, the authority information refers to a requirement for limiting a behavior of an application endowed when the application is installed, indicating a range within which the application is operable in the mobile telecommunication terminal. For example, when an application requires behaviors such as an SMS access, a Call Log access, and an Internet connection, such behaviors may be conducted only when the application has authorities for SMS access, Call Log access, and Internet connection, and these types of authority may be considered authority information. Types of authority information may include, for example, “READ_CONTACTS”, “SEND_SMS”, and the like. Here, “READ_CONTACTS” indicates authority of an application to read a user contact number and “SEND_SMS” indicates authority of an application to send an SMS to the outside.

Specifically, when installation of an application is completed, the system unit 102 transfers an installation complete message to the inspection unit 104. Upon receipt of the installation complete message, the inspection unit 104 then transfers a request message for requesting authority information of the installed application to the system unit 102 by using, for example, a system application programming interface (API). The system unit 102 transfers authority information of the application corresponding to the request message to the inspection unit 104.

The inspection unit 104 compares the received authority information with behavior information data stored in the behavior information DB 112 of the memory unit 110 to determine whether or not the application is a dangerous one.

When comparing the authority information and behavior information data, the inspection unit 104 measures scores of respective behaviors of the authority information based on preset malicious code behavior reference for example. When the sum of the scores is equal to or greater than a preset reference score, the inspection unit 104 may discriminate the corresponding application as a malicious code. Or, when a particular behavior to be performed only by a malicious code is included in the authority information, the inspection unit 104 may also discriminate the corresponding application as a malicious code. The inspection unit 104 outputs the result obtained by determining whether or not the corresponding application is dangerous based on the preset malicious code behavior reference, and the result information is transferred to the display unit 140 under the control of the controller 100 so as to be provided to the user.

Then, the user inputs a command for stopping the use of the corresponding application and/or deleting the corresponding application to the mobile communication terminal so that the mobile communication terminal can be prevented from a threat of the application.

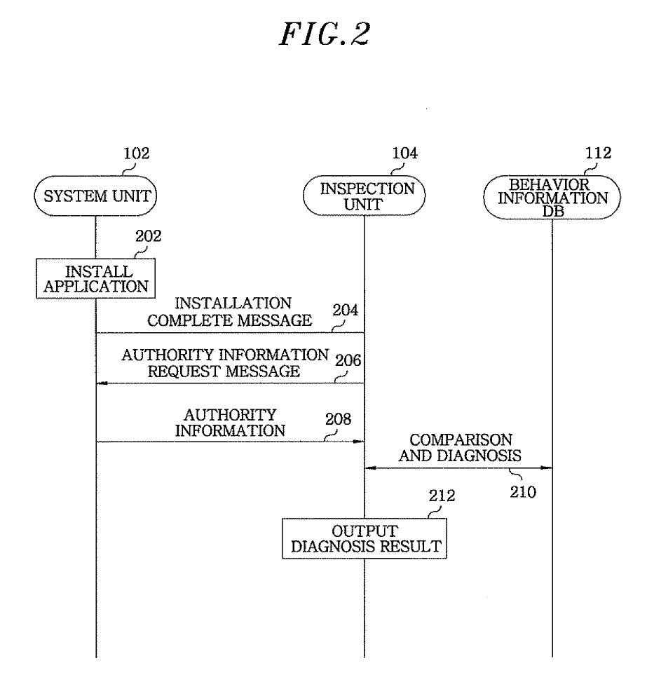

FIG. 2 is a flow chart illustrating a process of an operation of the mobile communication terminal when an application is provided thereto, in accordance with an embodiment of the present invention.

Referring to FIG. 2, the system unit 102 of the controller 100 installs an application provided through the data transmission/reception unit 120 or the input unit 130 in the memory unit 110 in step 202. When the installation is completed, the system unit 102 transfers an installation complete message of the application to the inspection unit 104 in step 204.

The inspection unit 104 requests authority information regarding the installed application to the system unit 102 in step 206, and the system unit 102 transfers the requested authority information regarding the application to the inspection unit 104 in step 208.

Thereafter, in step 210, the inspection unit 104 compares the transferred authority information and behavior information data stored in the behavior information DB 112 to diagnose whether or not the corresponding application is malicious.

The inspection unit 104 then outputs the result of the diagnosis as to whether or not the installed application is malicious in step 212, and the result information is provided to the user through the display unit 140.

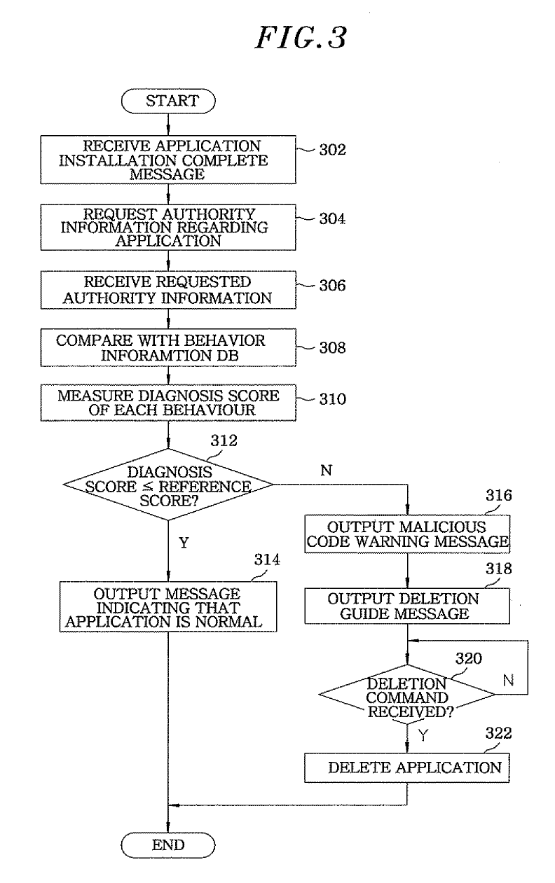

FIG. 3 is a flow chart illustrating a process performed by the inspection unit 104 in the controller 100 of the mobile communication terminal when an application is provided thereto, in accordance with an embodiment of the present invention.

Referring to FIG. 3, when an installation complete message regarding a particular application is received from the system unit 102 in step 302, the inspection unit 104 requests the system unit 102 for authority information regarding the corresponding application in step 304. In this regard, the request for authority information may be transmitted using a system API message.

The inspection unit 104 receives the authority information from the system unit 102 in step 306, and compares the authority information with the behavior information data previously stored in the behavior information DR 112 in step 308. Here, the behavior information data includes information regarding a behavior reference of a malicious code and a reference score used as a reference for determining the malicious code. The inspection unit 104 measures a diagnosis score of each behavior included in the authority information on a basis of the preset malicious code behavior reference through the comparison in step 308, in step 310. Next, when the sum of diagnosis scores is equal to or smaller than a preset reference score in step 312, the inspection unit 104 gives a diagnosis of the installed application as a normal code, and the process then goes to step 314 in which outputs a message indicating that the corresponding application is a normal application, as a diagnosis result. The output diagnosis result is provided to the user through the display unit 140.

However, when the sum of the diagnosis scores is higher than the reference score in step 312, the inspection unit 140 diagnoses the installed application as a malicious code, and the process then proceeds to step 316 in which the inspection unit 140 outputs a malicious code warning message as a diagnosis result. The diagnosis result is provided to the user through the display unit 140. Thereafter, the inspection unit 104 may provide an application stop and/or delete guide message through the display unit 140 in step 318. Here, the stop and/or delete guide message may be output upon receiving a confirmation of the malicious code warning message from the user, or may be output together with the malicious code warning message, through the display unit 140.

Subsequently, in step 320, the input unit 130 receives a delete command from the user and transfers it to the inspection unit 104, and the inspection unit 104 then requests the system unit 102 to delete the application. In step 322, the system unit 102 deletes the application and transfers the executed result to the inspection unit 104.

As described above, in the mobile communication terminal and the method with the behavior-based malicious code diagnosing capability in accordance with embodiments of the present invention, a malicious code is diagnosed based on authority information of an application as behavior-based information in the mobile communication terminal such as a smart terminal, thereby enhancing the stability and resource utilization of the mobile communication terminal.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A mobile communication terminal having a behavior-based malicious code diagnosing capability, the mobile communication terminal comprising:
a system unit configured to perform installation and deletion of an application, output an installation complete message when the installation of the application is completed, and provide authority information regarding the application when the authority information regarding the application is requested;
a behavior information database (DB) which stores behavior information data; and
an inspection unit configured to request the authority information to receive it from the system unit when receiving the installation complete message from the system unit, and compare the authority information with the behavior information data stored in the behavior information DB to diagnose whether or not the application is a malicious code.

2. The mobile communication terminal of claim 1, wherein the behavior information data includes preset malicious code behavior reference information and a reference score, and
wherein the inspection unit measures a score of each behavior included in the authority information on a basis of the malicious code behavior reference information, and the inspection unit diagnoses the application as a malicious code when the sum of the measured scores is higher than the reference score.

3. The mobile communication terminal of claim 2, wherein the inspection unit outputs a malicious code warning message and a deletion guide message regarding the application when the application is diagnosed as the malicious code.

4. The mobile communication terminal of claim 1, wherein the authority information is information for limiting a behavior endowed when the application is installed.

5. A method for diagnosing a malicious code on a behavior basis for use in a mobile communication terminal having a behavior information database (DB) that stores behavior information data, the method comprising:
performing installation of an application at a system unit of the mobile communication terminal;
transferring an installation complete message to an inspection unit when the installation of the application is completed;
upon receipt of the installation complete message, requesting authority information to the system unit at the inspection unit; and
comparing, at the inspection unit, the authority information received from the system unit with the behavior information data stored in the behavior information DB to diagnose whether or not the application is a malicious code.

6. The method of claim 5, wherein the behavior information data includes preset malicious code behavior reference information and a reference score, and
said comparing the authority information received from the system unit with the behavior information data includes:
measuring a score of each behavior included in the authority information on a basis of the malicious code behavior reference information; and
diagnosing the application as a malicious code when the sum of the measured scores is higher than the reference score.

7. The method of claim 6, further comprising:
outputting a malicious code warning message and a deletion guide message regarding the application when the application is diagnosed as the malicious code.

8. The method of claim 5, wherein the authority information is information for limiting a behavior endowed when the application is installed.

9. A method for diagnosing a malicious code on behavior basis in a mobile communication terminal having a behavior information database (DB) that stores behavior information data, the method comprising:
receiving, at an inspection unit, an installation complete message from the system unit when an application is installed in a system unit of the mobile communication terminal;
requesting, at the inspection unit, authority information to the system unit and receiving the authority information;
comparing the authority information with the behavior information data stored in the behavior information DB; and
measuring a score of each behavior included in the authority information on a basis of preset malicious code behavior reference information, and when the sum of the measured scores is higher than the reference score, diagnosing the application as a malicious code.

10. The method of claim 9, further comprising:
outputting a malicious code warning message and a deletion guide message regarding the application when the application is diagnosed as the malicious code.

11. The method of claim 9, wherein the authority information is information for limiting a behavior endowed when the application is installed.
